(19) United States
(12) Patent Application Publication
(10) Pub. No.: US 2003/0152736 A1
(43) Pub. Date: Aug. 14, 2003

(54) Plate mat

(76) Inventor: Edwin Bass, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/365,766

(22) Filed: Feb. 13, 2003

Related U.S. Application Data
(60) Provisional application No. 60/356,984, filed on Feb. 13, 2002.

(51) Int. Cl. B32B 9/00

(52) U.S. Cl. 428/40.1; 428/157

(57) ABSTRACT

A plate mat (10) for use in serving food to prevent spillage of the food includes a mat having a substantially flat underside (U) for the mat to lay flat when placed upon a generally flat surface (T). An adhesive backing (12) is formed on the underside of the mat to securely affix the mat to a surface upon which it is placed so the mat cannot be moved about the surface. A raised area (20) extending about an upper surface of the mat and defining at least one space (22) on the upper surface of the mat in which food is placed, so to contain the food within the space and prevent it from being scattered outside the space over the surface on which the mat is placed.

### CROSS REFERENCE TO RELATED APPLICATIONS

Provisional patent application No. 60/356,984 filed Feb. 13, 2002.

### STATEMENT REGARDING FEDERALLY SPONSORED RESEARCH OR DEVELOPMENT

Not applicable.

### BACKGROUND OF THE INVENTION

This invention relates to place mats, and more particularly, to a plate mat for use in homes and restaurants. When dining in restaurants, small children, whether seated in high chairs, or at the table, tend to play with food placed in front of them, often dispersing it all over the tray, part of the table immediately in front of them, knocking it on the floor, and generally making a mess. Not only is the result unsightly, but the server or bus person has to spend a considerable amount of time cleaning up both the table and the area on the floor around it. Conventional place mats are of little help in alleviating the problem since they are not fixed in place and can be shoved or moved about, actually helping scatter the food placed on them. The same is true when feeding the child at home; except here it is the parent who must clean up the mess.

### BRIEF SUMMARY OF THE INVENTION

Among the several objects of the present invention is a plate mat for use in restaurants and homes. The mat has an adhesive backing so it can be securely affixed to a table top or tray. The upper surface of the mat has an enclosed space formed by a ridge extending about the top face of the mat and defining the perimeter of the enclosed space. Food placed in the enclosed space cannot now be readily pushed, shoved, or knocked off the mat by a child. When the meal is over, a parent or waitress, or clean-up person, simply peels the mat up from the table top or tray for ready disposal into a trash container. Since food particles are not now scattered about, little additional clean-up is required. Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 illustrates a high chair tray on which a plate mat of the present invention is placed;

FIG. 2 illustrates a table top on which the plate mat is set;

FIGS. 3A-3G illustrate different mat configurations; and;

FIGS. 4A and 4B illustrate the underside of a plate mat with various areas of adhesive for securing the mat to a tray top or table top, and FIG. 4C illustrates a tab formed on one side of the mat for removing the mat; and

FIG. 5 illustrates a stacked arrangement of the plate mats prior to use.

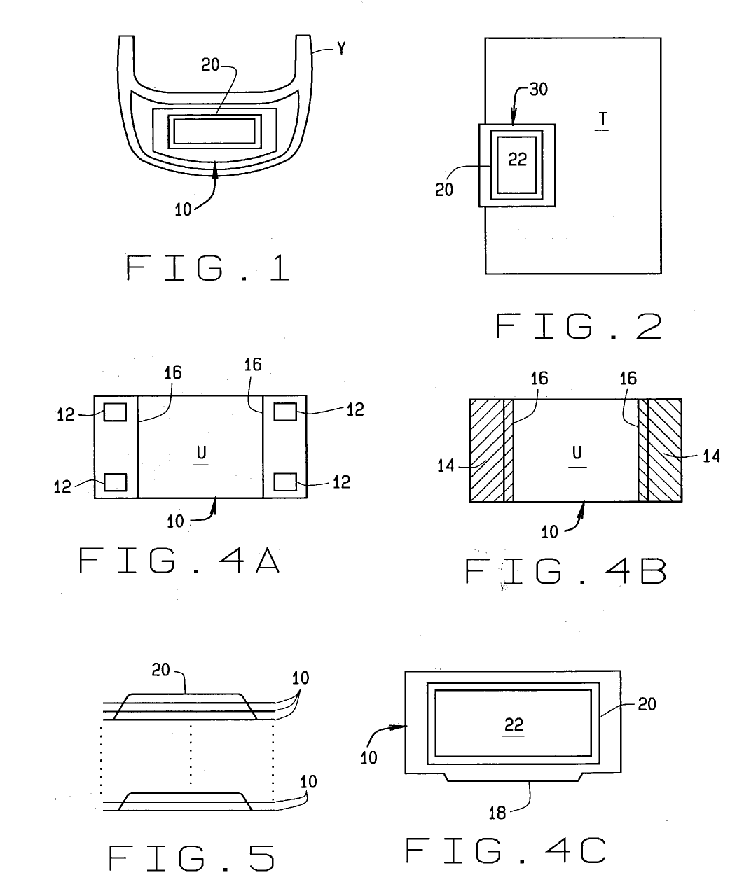

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

Referring to the drawings, a first embodiment of a plate mat of the present invention is indicated generally 10. The plate is sized and has an outer contour so to conveniently fit on a tray Y of a child's high chair. On the underside U of the plate mat are one or more areas 12 (see FIG. 4) of an adhesive material. The areas of adhesive can be patches located at the corners of the mat as shown in FIG. 4A, or strips 14 extending along opposed sides of the mat as shown in FIG. 4B. In either embodiment, a peel-away strip 16 covers the adhesive area prior to use of the mat. The strips 16 are removed just prior to placing mat 10 on the tray. The adhesive areas adhere the mat to the top of the tray so the child cannot push or otherwise dislodge it and spill the food placed on the mat. As shown in FIG. 4A, a length of non-adhesive area extends from the area of adhesive to the side of the tray. This makes it easier for the person removing the mat after a meal to pull it away from the tray top. Or, a pull strip 18 can extend from one side of the mat as shown in FIG. 4C to make it easier to remove the mat by peeling it away from the tray top or table top.

As shown in the drawings, on the top surface of the map is raised surface or ridge 20 which extends about the mat and encloses a food serving section 22 generally in the middle of the mat. Food for the child is placed in the area 22, which is a clean, sanitary surface. The food is typically small, bite sized pieces of fruit and vegetables. The height of the ridge is such that food placed in section 22 cannot readily be scattered outside this area, even if the child is extremely active. At the same time, the food is placed immediately in front of the child so he or she has easy access to it; and can seize it with a spoon or their fingers to put in their mouth. If someone feeds the child, they can also readily access it.

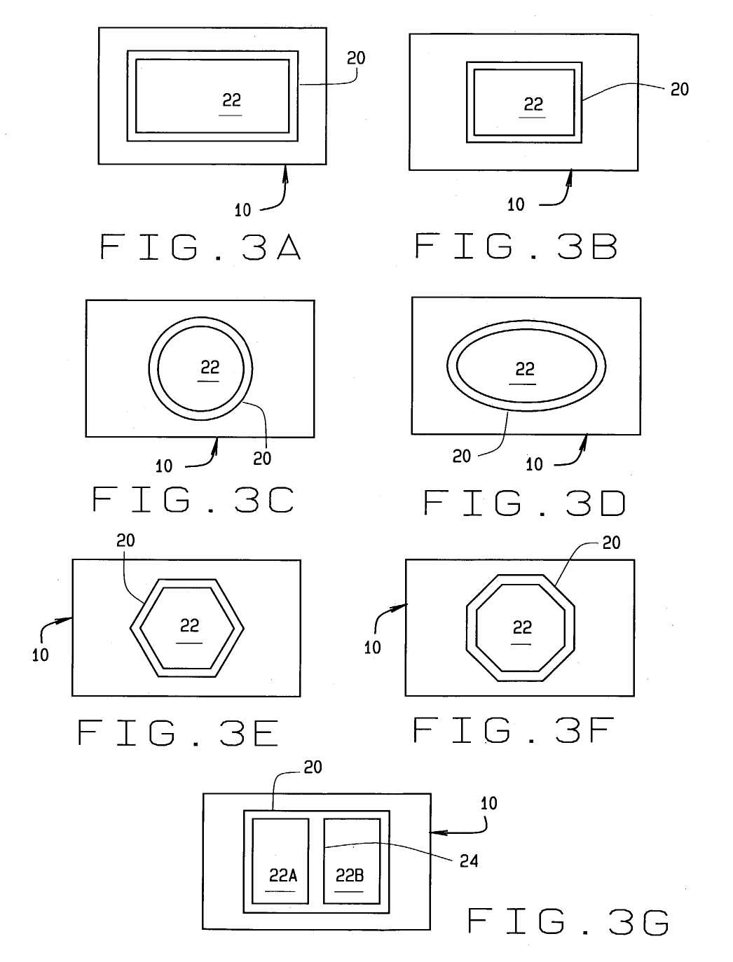

The size and shape of section 22 can be any number of convenient shapes including generally rectangular or square as shown in FIGS. 3A and 3B, circular or oval, as shown in FIGS. 3C and 3D, or other polygonal shapes as shown in FIGS. 3E and 3F. Although not shown in the drawings, the shapes could be other well recognizable shapes such as star shapes, crescents, etc., or the outlines of animals or cartoon and similar characters.

In addition, as shown in FIG. 3G, ridge 20 may include a segment 24 which divides food section 22 into separate compartments 22A and 22B. those skilled in the art will understand that the arrangement shown in FIG. 36 is illustrative only and other configurations can be used with departing from the scope of the invention. Referring to FIG. 2, another embodiment of the plate mat is indicated generally 30. This plate mat is for use on regular tables and is affixed to a top surface T of the table. The mat is generally rectangular in shape with adhesive areas on its underside similar to those previously described. Further, while plate mat 30 can be affixed solely to the top of the table, as shown in FIG. 2, the mat can also be folded over so a portion can be affixed to the underside of the table. Otherwise, the construction of the plate mat is similar to that previously described as is the shape of the food placement section as shown in FIGS. 3A-3G. It is a feature of the plate mats of the present invention that they are made so as to be stackable as shown in FIG. 5.

Finally, a plate mat 10 can be made which has an adhesive backing so when placed on a tray or tabletop, the mat will not slide. The mat, however, does not have ridges defining food areas on its upper surface. Rather, the top surface of the mat is flat While this construction may allow food placed on the mat to be scattered about the mat, because the mat is secured in place, it cannot slide over of off the table top allowing a mess to be made.

In view of the above, it will be seen that the several objects and advantages of the present invention have been achieved and other advantageous results have been obtained.

1. A plate mat (10) for use in serving food to prevent spillage of the food comprising:
a mat having a substantially flat underside (U) for the mat to lay flat when placed upon a generally flat surface (T); and,
an adhesive backing (12) formed on the underside of the mat to securely affix the mat to a surface upon which it is placed so the mat cannot be moved about the surface.

2. The plate mat of claim 1 further including a raised area (20) extending at least partially around an upper surface of the mat and defining a space (22) on the upper surface of the mat in which food is placed, so to contain the food within the space and prevent it from being scattered outside the space.

3. The plate mat of claim 1 wherein the mat is generally rectangular and the adhesive backing comprises patches (12) of adhesive material located adjacent corners of the mat.

4. The plate mat of claim 1 wherein the mat is generally rectangular and the adhesive backing comprises strips (14) of adhesive material extending along opposite sides of the mat.

5. The plate mat of claims 3 or 4 further including pull away strips (16) covering the adhesive material, the pull away strips being removed prior to the mat being set in place.

6. The plate mat of claim 1 wherein the mat is generally rectangular and includes a pull strip (18) extending outwardly from one side of the mat for a person to readily tear the mat away from the surface by pulling on the tear strip.

7. The plate mat of claim 2 wherein the raised area on the upper surface of the forms comprises a ridge defining a generally rectangular area for the food.

8. The plate mat of claim 2 wherein the raised area on the upper surface of the forms comprises a ridge defining a generally circular area for the food.

9. The plate mat of claim 2 wherein the raised area on the upper surface of the forms comprises a ridge defining a generally oval shaped area for the food.

10. The plate mat of claim 2 wherein the raised area on the upper surface of the forms comprises a ridge defining a generally hexagonal shaped area for the food.

11. The plate mat of claim 2 wherein the raised area on the upper surface of the forms comprises a ridge defining a generally octagonal shaped area for the food.

12. The plate mat of claim 2 wherein the raised area on the upper surface of the forms comprises a ridge defining a plurality of areas for food to be set on the mat.

13. A plate mat (10) for use in serving food to prevent spillage of the food comprising:
a mat having a substantially flat underside (U) for the mat to lay flat when placed upon a generally flat surface (T);
an adhesive backing (12) formed on the underside of the mat to securely affix the mat to a surface upon which it is placed so the mat cannot be moved about the surface; and,
a raised area (20) extending about an upper surface of the mat and defining at least one space (22) on the upper surface of the mat in which food is placed, so to contain the food within the space and prevent it from being scattered outside the space over the surface on which the mat is placed.

14. The plate mat of claim 13 in which the adhesive material covers a portion of the underside of the mat, and the mat further includes pull away strips (16) covering the adhesive material, the pull away strips being removed prior to the mat being set in place.

15. The plate mat of claim 14 wherein the mat is generally rectangular and includes a pull strip (18) extending outwardly from one side of the mat for a person to readily tear the mat away from the surface by pulling on the tear strip.

16. The plate mat of claim 14 wherein the raised area on the upper surface of the forms comprises a ridge defining a generally polygonal shaped area for the food.

17. The plate mat of claim 14 wherein the raised area on the upper surface of the forms comprises a ridge defining a generally circular shaped area for the food.

18. The plate mat of claim 14 wherein the raised area on the upper surface of the forms comprises a ridge defining a generally oval shaped area for the food.

19. The plate mat of claim 14 wherein the raised area on the upper surface of the forms comprises a ridge defining a plurality of areas for food to be set on the mat.

20. The plate mat of claim 16 wherein the ridge defines a generally rectangular shaped area for the food.
